(19) United States
(12) Patent Application Publication
(10) Pub. No.: US 2016/0206515 A1
(43) Pub. Date: Jul. 21, 2016

(54) BABY FEEDING DEVICE AND SYSTEM

(71) Applicant: Hal Snarr, Salt Lake City, UT (US)

(72) Inventor: Hal Snarr, Salt Lake City, UT (US)

(21) Appl. No.: 14/599,476

(22) Filed: Jan. 17, 2015

(51) Int. Cl. A61J 9/00

(52) U.S. Cl. CPC A61J 9/006; A61J 9/008

(57) ABSTRACT

A system and device for feeding infants and babies semi-solid foods while limiting messes may include a hollow food chamber that can be filled with food using a plunger and a suction loading tube attachment. The suction loading tube attachment may remain in the baby food container to limit spills. The baby then sucks the food from the hollow food chamber through a nipple that is generally over-sized with an enlarged nipple opening.

### BACKGROUND OF THE INVENTION

1. The Field of the Invention

The present invention relates to baby feeding devices and, more specifically, to a baby feeding device for feeding babies semi-solid foods.

2. State of the Art

Babies typically eat only liquids, such as formula or breast milk, for the first 4-6 months of their lives. These liquids are consumed via a nipple (either their mother's nipple or an artificial nipple). After 4-6 months, infants begin to transition to solid foods. This often starts with semi-solid foods, such as rice cereal made with formula or breast milk, and cooked, mashed fruits and vegetables. These semi-solid foods are fed to babies most often with a spoon. Because babies are used to sucking to get food into their mouths, they have difficulty transitioning to eating solid foods from spoons. This can result in frustration for the hungry baby, and also a mess as babies often eject food from a spoon due to the forward thrust of their tongues.

Accordingly, there is a need for an improved device and method for feeding babies and infants semi-solid foods.

### SUMMARY

A baby feeding device is provided, including an apparatus and a method of use.

According to one aspect, the device generally comprises a hollow food chamber with a plunger and a nipple removably attachable to the distal end.

According to another aspect, the plunger slidably engages the interior diameter of the hollow food chamber and is used to load food into the food chamber.

According to another aspect, there is provided a suction loading tube that is removably attachable to the hollow food chamber. In some configurations, one end of the suction loading tube may remain in the food container and the other end may be attached to the food chamber.

According to some aspects, the device may include a base, and the suction loading tube may be insertable into the base to load food. The channel through which the suction loading tube may be insertable may be selectably closeable by any suitable means known in the art.

According to another aspect, there is provided a method of loading the device with semi-solid baby food and feeding the semi-solid food to a baby.

These and other aspects of the present invention are realized in a baby feeding device and method shown and described in the following figures and related description. It will be appreciated that various configurations of the invention may not include each aspect set forth above and aspects discussed above shall not be read into the claims unless specifically described therein.

### BRIEF DESCRIPTION OF THE DRAWINGS

Various configurations of the present invention are shown and described in reference to the numbered drawings wherein:

FIG. 1 shows a perspective, partially exploded view of a baby feeding device;

FIG. 2 shows a perspective view of a possible configuration of a food chamber and base of a baby feeding device;

FIG. 3A shows a perspective view of another configuration of a baby feeding device;

FIG. 3B shows a sideview of the base of the baby feeding device shown in FIG. 3A;

FIG. 3C shows a side view of the suction loading tube of the baby feeding device shown in FIG. 3A;

FIG. 4A shows a side view of an opening of a suction loading tube channel on a base according to one configuration;

FIG. 4B shows an end view of a suction loading tube that could be used in conjunction with the base shown in FIG. 4A;

FIG. 5A shows a partial cut-away proximal end view of a configuration of a base that could be used with a baby feeding device;

FIG. 5B shows a partial cut-away proximal end view of another configuration of a base that could be used with a baby feeding device;

FIG. 6A shows a perspective view of another exemplary configuration of a baby feeding device;

FIG. 6B shows a side, cut-away view of the base of the baby feeding device shown in FIG. 6A;

FIG. 7A shows a baby feeding device in conjunction with a container of baby food; and

FIG. 7B shows another configuration of a baby feeding device in conjunction with a container of baby food.

It will be appreciated that the drawings are illustrative and not limiting of the scope of the invention which is defined by the appended claims. The configurations shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every configuration need accomplish all advantages of the present invention.

### DETAILED DESCRIPTION

The invention and accompanying drawings will now be discussed in reference to the numerals provided therein so as to enable one skilled in the art to practice the present invention. The skilled artisan will understand, however, that the apparatuses, systems and methods described below can be practiced without employing these specific details, or that they can be used for purposes other than those described herein. Indeed, they can be modified and can be used in conjunction with products and techniques known to those of skill in the art in light of the present disclosure. The drawings and descriptions are intended to be exemplary of various aspects of the invention and are not intended to narrow the scope of the appended claims. Furthermore, it will be appreciated that the drawings may show aspects of the invention in isolation and the elements in one figure may be used in conjunction with elements shown in other figures.

Reference in the specification to “one configuration” or “a configuration” means that a particular feature, structure, or characteristic described in connection with the configuration is included in at least one configuration, but is not a requirement that such feature, structure or characteristic be present in any particular configuration unless expressly set forth in the claims as being present. The appearances of the phrase “in one configuration” in various places may not necessarily limit the inclusion of a particular element of the invention to a single configuration, rather the element may be included in other or all configurations discussed herein.

Furthermore, the described features, structures, or characteristics of configurations of the invention may be combined in any suitable manner in one or more configurations. In the following description, numerous specific details are provided, such as examples of products or manufacturing techniques that may be used, to provide a thorough understanding of configurations of the invention. One skilled in the relevant art will recognize, however, that configurations of the invention may be practiced without one or more of the specific details, or with other methods, components, materials, and so forth. In other instances, well-known structures, materials, or operations are not shown or described in detail to avoid obscuring aspects of the invention.

Before the present invention is disclosed and described in detail, it should be understood that the present disclosure is not limited to any particular structures, process steps, or materials discussed or disclosed herein, but is extended to include equivalents thereof as would be recognized by those of ordinarily skill in the relevant art. More specifically, the invention is defined by the terms set forth in the claims. It should also be understood that terminology contained herein is used for the purpose of describing particular aspects of the invention only and is not intended to limit the invention to the aspects or configurations shown unless expressly indicated as such. Likewise, the discussion of any particular aspect of the invention is not to be understood as a requirement that such aspect is required to be present apart from an express inclusion of the aspect in the claims.

It should also be noted that, as used in this specification and the appended claims, singular forms such as “a,” “an,” and “the” may include the plural unless the context clearly dictates otherwise. Thus, for example, reference to “a channel” may include one or more of such springs, and reference to “the backing” may include reference to one or more of such layers.

As used herein, the term “substantially” refers to the complete or nearly complete extent or degree of an action, characteristic, property, state, structure, item, or result to function as indicated. For example, an object, such as tubing, that is “substantially” enclosed would mean that the object is either completely enclosed or nearly completely enclosed. The exact allowable degree of deviation from absolute completeness may in some cases depend on the specific context, such that enclosing nearly all of the length of a piece of tubing would be substantially enclosed, even if the distal end of the structure enclosing the tubing had a slit or channel formed along a portion thereof. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it lacked a bottom.

As used herein, the term “about” is used to provide flexibility to a numerical range endpoint by providing that a given value may be “a little above” or “a little below” the endpoint while still accomplishing the function associated with the range.

As used herein, a plurality of items, structural elements, compositional elements, and/or materials may be presented in a common list for convenience. However, these lists should be construed as though each member of the list is individually identified as a separate and unique member.

Concentrations, amounts, proportions and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

As used herein, “proximal” and “distal” are defined in relation to the caregiver using the baby feeding device. Thus, the proximal end is the end closest to the caregiver and the distal end is the end farthest from the caregiver. The distal end has the nipple attached and is placed in the baby's mouth.

As used herein, “semi-solid food” means food that can be passed through a nipple opening under sufficient force. Most often, this will be soft foods that are appropriate for feeding infants, such as mashed vegetables and fruits. It can also include reconstituted foods, such as rice cereal, and other foods that are small enough or liquid enough to pass through the food delivery tube.

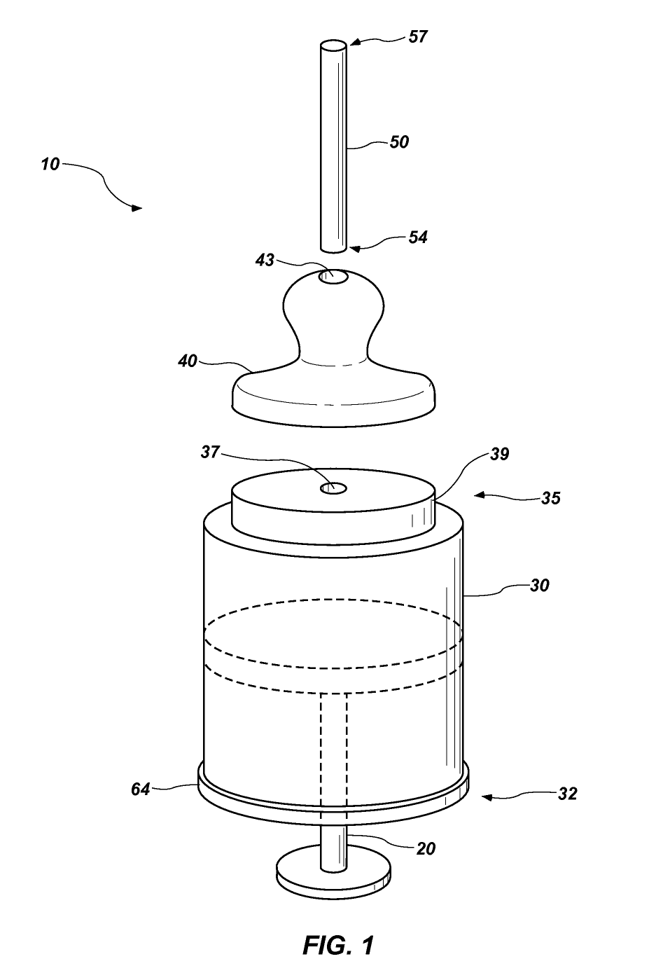

Turning now to FIG. 1, a perspective view of a baby feeding device, generally indicated at 10, is shown. The device generally includes a plunger 20, a hollow food chamber 30, a nipple 40, and a suction loading tube 50. As described below, the suction loading tube 50 is used to first load the hollow food chamber 30 with a semi-solid baby food and is then removed. The baby then sucks the nipple 40 and the food from the food chamber 30 moves downwardly through the nipple 40 into the baby's mouth.

The food chamber 30 is generally hollow and may be any shape desired. The food chamber is shown in the accompanied drawings as being round, but could also be other shapes. The food chamber 30 has a proximal end 32 that is generally open and is configured to receive plunger 20. According to design aesthetics, the food chamber 30 may be formed such that it has a length less than twice the interior diameter. This may be a more pleasing proportion; however, any shape of the food chamber that is desired may be used.

The plunger 20 diameter may be approximately equal or slightly less than the interior diameter of the food chamber 30, such that the plunger is slidably engageable with the interior diameter of the food chamber 30. Additionally, the plunger may be at least partially formed of a material that has an increased coefficient of friction, such as a rubber material or the like, such that the plunger 20 frictionally engages the interior diameter of the food chamber 30. As the plunger 20 frictionally engages the interior diameter of the food chamber 30, the plunger 20 may push all food downwardly as the baby sucks from the nipple 40. This may have the advantage of leaving the interior diameter of the food chamber 30 clean as food is sucked out and the plunger moves distally.

The plunger 20 also allows food to be easily loaded into the food chamber 30 by use of suction force. Before loading food into the food chamber 30, the plunger 20 is moved into a distal position, preferably to the most distal position against the distal end 35 of the food chamber 30. The distal end 35 of the food chamber 30 includes a food passage opening 37. The proximal end 54 of the suction loading tube 50 is placed in the food passage opening 37, and the distal end 57 of the suction loading tube 50 is placed in a container having semi-solid baby food therein. The plunger 20 is then moved proximally, and as the plunger 20 moves proximally, food is drawn through the suction loading tube 50, the food passage opening 37, and into the hollow food chamber 30. When the desired amount of food has been loaded, the suction loading tube 50 may be removed, and the nipple 40 placed on the attachment mechanism 39 of the food chamber 30. The suction loading tube 50 may be left in place in the container of baby food, so that it will be in place if additional food is desired, and to prevent any spills or drips from food on the suction loading tube to the surroundings.

Alternatively, the nipple 40 may be first placed on the food chamber 30 via the attachment mechanism, and the suction loading tube 50 then placed through the nipple opening 43 and into the food passage opening 37. After the desired amount of food has been loaded, the suction loading tube 50 may be removed by pulling it out of the food passage opening 37 and through the nipple opening 43. A friction fit between the suction loading tube 50 and the food passage opening 37 may make placement and removal of the suction loading tube 50 in the food passage opening 37 simple. The friction fit or other suitable type of connection may be configured such that an adult can place the suction loading tube 50 and remove the suction loading tube 50 with one hand (leaving the other hand free to hold or soothe a baby).

The nipple 40 may be a generally oversized nipple compared to nipples used on standard baby's bottles. The nipple opening 43 may also be larger than a standard nipple hole opening for milk or formula, so semi-solid food can pass more easily through the nipple opening 43. For example, the nipple opening 43 may be around 1 centimeter in diameter. In some configurations, there may be provided several nipples 40 with different sized nipple openings 43. For example, babies just beginning to eat solid foods may eat rice cereal that is diluted with formula or breast-milk, and a smaller nipple opening 43 may be desired. As the baby gets older and eats more solid food, such as mashed fruits and vegetables, a larger nipple opening 43 may be desired. Similarly, more than one opening may be desired. In one configuration, the baby feeding device may include a food chamber 30 with multiple nipples 40 of different nipple opening 43 sizes.

The nipple 40 may be attached to the food chamber by any suitable means, and may be preferably removably attached to allow easily cleaning and interchanging of nipples. For example, the attachment mechanism 39 may be a threading on the distal end 35 of the food chamber 30. The attachment mechanism 39 may also be a snap fit or a friction fit, or any other suitable means.

The suction loading tube 50 may be formed of a resilient plastic, such that it is able to withstand longitudinal pressure (as will likely occur during placement of the suction loading tube 50 through the food passage opening 37 and also during loading of the food) and not bend. The suction loading tube 50 may be formed such that it is rigid or semi-rigid. For example, the suction loading tube 50 may be formed of a hard plastic, such as polysterene or the like. The suction loading tube 50 may also be flexible, if desired. The suction loading tube 50 has a circumference such that it may be attached to the food passage opening 37 of the food chamber 30. In some configurations, the suction loading tube 50 is configured to frictionally fit within the food passage opening 37.

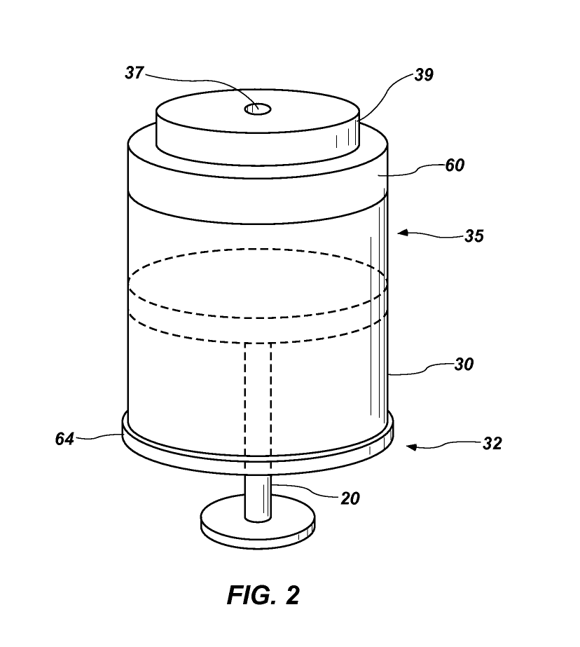

Turning now to FIG. 2, there is shown an alternative configuration of a baby feeding device. In this configuration, the distal end 35 of the hollow food chamber comprises a removable base 60. The distal end 35 of the food chamber 30 may be generally open in this configuration. The base 60 is removably attached to the food chamber 30, for example, by threads on the outer circumference of the distal end 35 of the food chamber 30 and complementary threads on the interior of the base 60. Other suitable attachment mechanisms may be used.

In the exemplary configuration show in FIG. 2, the removable base 60 has the attachment mechanism 39 for attaching the nipple 40 to the base. The attachment mechanism may be a friction or snap-fit, or even a threading on the base and a complementary threading on the nipple. The removable base also defines the food passage opening 37. This type of configuration may simplify the washing of the baby feeding apparatus and may be simpler to manufacture.

FIG. 2 also shows the proximal end 32 of the food chamber 30 as being open. The proximal end 32 may also include a cap 64. The cap 64 may be removably attached to the food chamber 30, such as a threaded cap, and may prevent the plunger 20 from being pulled too far proximally and exiting the food chamber (which could also cause any food in the food chamber to exit the food chamber). This could happen if an adult mistakenly pulled the plunger too hard or too fast, or if a baby grabbed the device and tried to remove the plunger. This may prevent unnecessary messes associated with use of the baby feeding device.

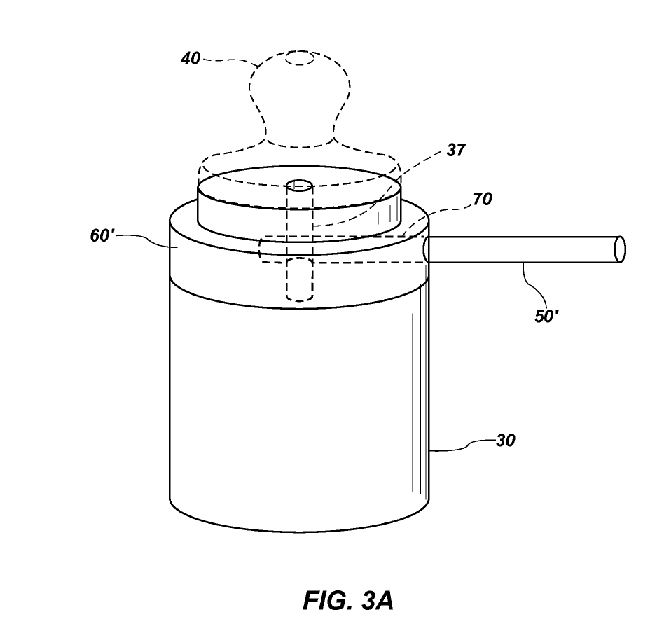

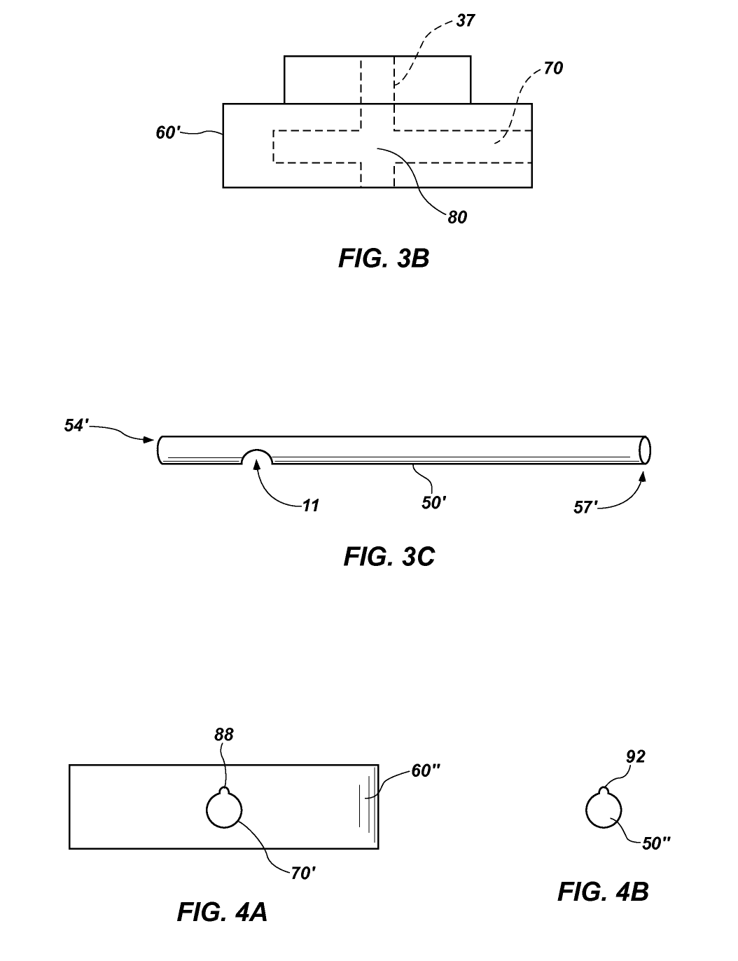

Turning now to FIG. 3A, there is shown another possible configuration for a baby feeding device. In this configuration, the food is loaded into the food chamber 30 through the side of the base 60′, rather than through the distal end as shown in the previous configurations. This configuration uses a removable base 60′ with a suction loading tube channel 70 (shown in dashed lines in FIG. 3A) and a suction loading tube 50′ with a void at the proximal end, as explained in more detail below. (For convenience, the nipple 40 is shown in silhouette in FIG. 3A and the plunger is not shown.)

The removable base 60′ has a suction loading tube channel 70 bored, or otherwise formed, part-way through the base 60′. The suction loading tube channel 70 has a diameter to receive the suction loading tube 50′. For example, the suction loading tube channel 70 may have a diameter of about 1 centimeter. The removable base 60′ also includes the food passage opening 37 (similar to previously shown configurations). FIG. 3A shows the food passage opening 37 and the suction loading tube channel 70 in dashed lines. The suction loading tube channel 70 intersects the food passage opening 37. FIG. 3B shows a side view of the removable base 60′ with the suction loading tube channel 70 and the food passage opening 37 in dashed lines. The intersection is indicated at 80.

FIG. 3C shows a side view of a suction loading tube 50′ that may be used in conjunction with the removable base 60′. The suction loading tube 50′ is hollow and has an open distal end 57′ for inserting into a container of baby food. Disposed near the proximal end 54′ of the suction loading tube 50′ is a void 11. This void 11 is positioned such that when the suction loading tube 50′ is inserted into the suction loading tube channel 70, the void meets the point where the food passage opening 37 and the suction loading tube channel 70 intersect (indicated at 80).

Because the void 11 should be facing the proximal end of the device (i.e., towards the food chamber 30) to load food, the base and the suction loading tube 50′ may include a guide groove 88 in the base and a guide protrusion 92 on the suction loading tube 50′. This may ensure that the suction loading tube 50′ is properly inserted to load food. FIG. 4A shows a side view of a base 60″ with a guide groove 88 in the suction loading tube channel 70′ and FIG. 4B shows an end view of a complementary suction loading tube 50″ with a guide protrusion 92.

The suction loading tube channel 70 has an opening in the sidewall of the removable base 60′ to allow the suction loading tube 50′ to be inserted. This sidewall opening may be selectively closable (either at the sidewall or at a position closer to the intersection of the food passage opening 37 and the suction loading tube channel 70). In some configurations, the sidewall opening is closed unless the suction loading tube 50′ is currently inserted through the suction loading tube channel 70. For example, when loading food into the food chamber 30, the suction loading tube channel 70 should be open to allow the suction loading tube 50′ to be inserted. But when food has already been loaded and is then being fed to the baby, it is desirable to close the suction loading tube channel 70 so that food from the food chamber 30 can only exit through the food passage opening 37 and into the nipple (otherwise food from the food chamber 30 could also exit through the suction loading tube channel 70). Any suitable means known in the art can be used to selectively close and open the suction loading tube channel 70. For example, a spring-loaded push-actuated gate may be used, or a one-way flap or valve. Or any other suitable mechanism known in the art may be used.

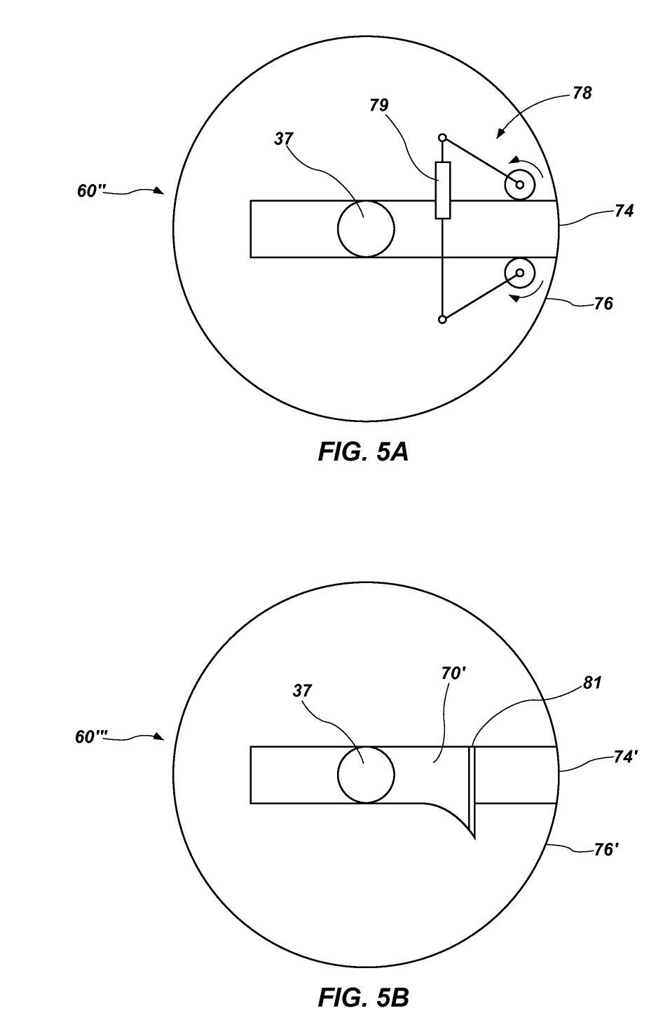

For example, FIG. 5A shows a proximal end, cut-away view of a removable base 60′ having a mechanism that slidably moves to open and close the suction loading tube channel 70 as the suction loading tube 50′ is inserted and pulled out of the suction loading tube channel 70. In this possible configuration, the mechanism 78 includes wheels that frictionally engage the suction loading tube 50′ and rotate as the suction loading tube 50′ moves past them. The rotational movement of the wheels causes translational movement of an attached gate 79 (as indicated by the arrows in FIG. 5A). The gate 79 blocks the entrance 74 in the sidewall 76 of the base 60′. The gate 79 may be configured such that it is in a closed position, and opens when the suction loading tube 50′ is inserted, and then closes again when the suction loading tube 50′ is removed.

Another possible configuration for a closure for the sidewall entrance 74′ of the suction loading tube channel 70′ in a base 60′″ is shown in FIG. 5B. The suction loading tube channel 70′ is formed to make space for a resilient, one-way flap 81. The flap remains in the closed position (shown in FIG. 5B) until a suction loading tube 50′ is inserted through the suction loading tube channel 70′, and then it can be deformed to make room for the suction loading tube 50′ to pass. Once the suction loading tube 50′ is removed, the flap 81 returns to the closed position.

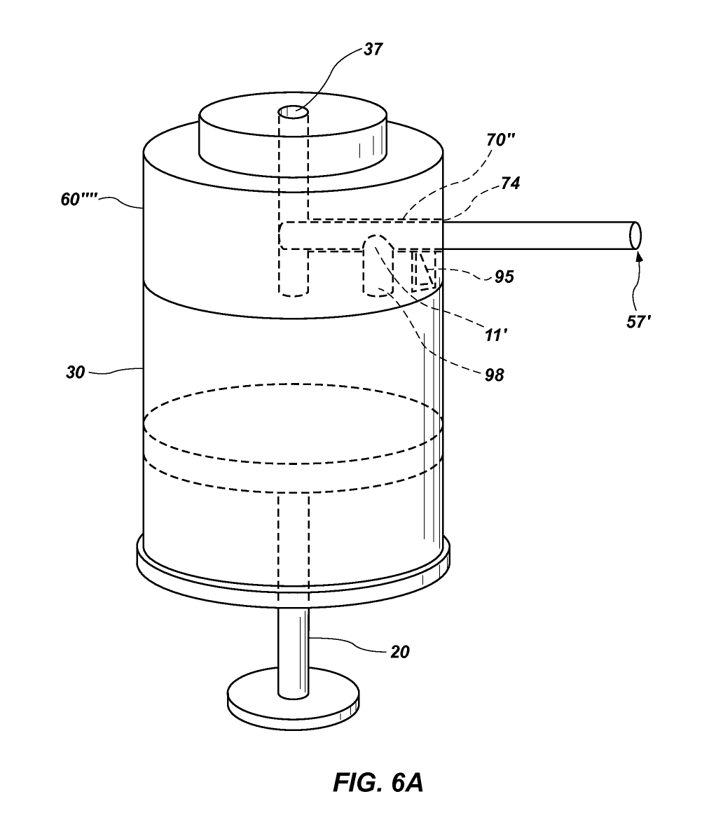

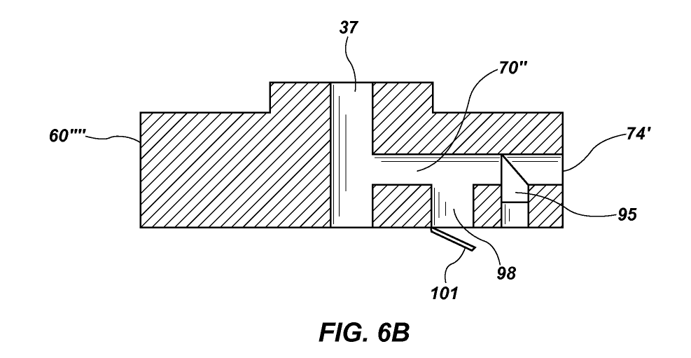

Turning now to FIG. 6A, there is shown another exemplary configuration for a removable base, 60″″ attached to a food chamber 30. In this configuration the suction loading tube channel 70″ further includes a food loading passageway 98 (both shown in dashed lines in FIG. 6A). The food loading passageway 98 may be selectively closeable, such as by use of a one-way resilient flap 101 (FIG. 6B). Food could enter the food chamber from the suction loading tube and through the flap, but food could not exit the food chamber past the flap.

A suction loading tube 50″ that could be used in conjunction with the base is shown inserted through the suction loading tube channel 70″. It can be seen that the void 11′ in the proximal end of the suction loading tube is positioned such that it will meet the food loading passageway 98 when the suction loading tube 50″ is inserted into the suction loading tube channel 70′.

To load food into the chamber 30 in this configuration, the proximal end of the suction loading tube may be inserted into the suction loading tube channel 70′, and the plunger 20 brought to a distal position. The distal end 57′ of the suction loading tube may then be inserted into a container of baby food. The plunger is then moved proximally to suck food from the container, through the distal end of the suction loading tube, through the void 11′, through the food loading passageway 98 and past the flap 101, and into the food chamber 30.

FIG. 6B shows a side, cut-away view of the base 60″″ of FIG. 6A. According to this configuration, the entrance 74′ of the suction loading tube channel 70′ is blocked by a spring-loaded push activated gate 95. Any other means suitable may be used to selectively close the entrance 74′ of the suction loading tube channel 70′.

It will be appreciated that numerous other configurations are possible for the base portion and the complementary suction loading tube. For example, the suction loading tube passageway need not extend to intersect with the food passage opening. Similarly, varying types of closures may be used to selectively open and close the suction loading tube passageway. The configurations shown in the figures and described herein are merely exemplary configurations and many more are possible and are within the scope of the present invention.

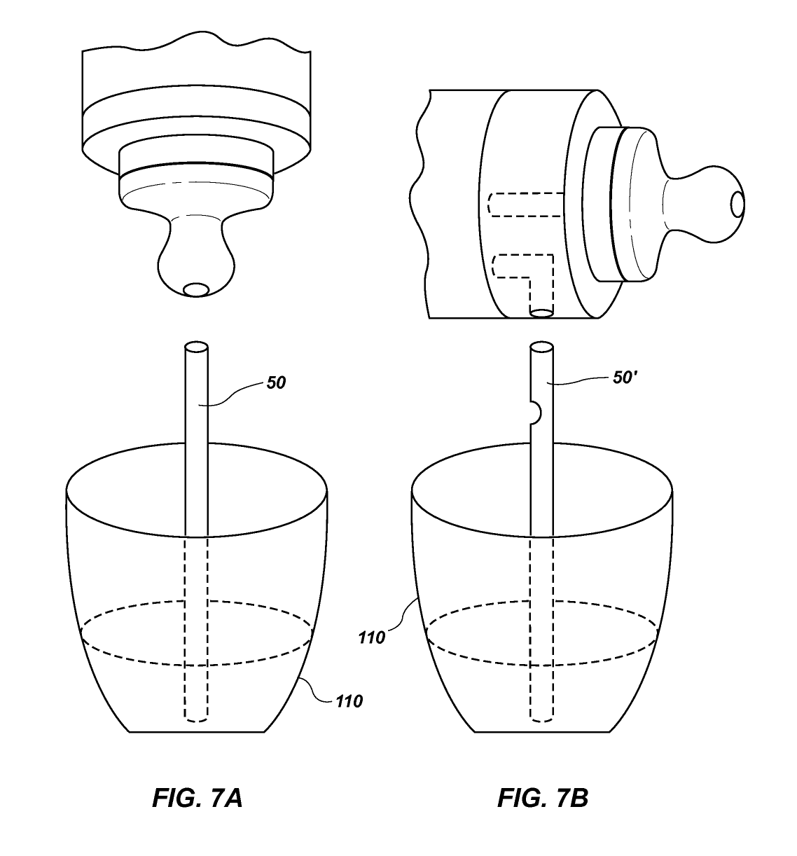

Turning now to FIGS. 7A and 7B, there is shown a baby feeding device, loading food into the food chamber 30 from a container of baby food 110. It can be seen that the suction loading tube 50 will get baby food on it as it comes into contact with the baby food in the container. However, according to the present design, the suction loading tube 50 may be left in the container after the food is loaded, so no mess from the suction loading tube 50 will spread to any other areas (such as the baby or the adult or the surrounding environment).

In use, the caregiver first makes or obtains a semi-solid baby food for the baby. Then, in a configuration similar to that shown in FIG. 7A, the caregiver puts the nipple onto the food chamber and ensures the plunger is in the distal position. Then, the caregiver inserts the proximal end of the suction loading tube 50 into the food passage opening and the distal end into the baby food. (It will be appreciated that these steps may be taken in a different order.) The caregiver then moves the plunger proximally, and food is sucked up from the container 110 into the suction loading tube and into the food chamber. Once the desired amount of food is in the food chamber, the suction loading tube is removed from the food passage opening and the nipple is placed in the infant or baby's mouth. The suction loading tube may remain in the baby food container.

Similarly, for use of a configuration wherein the food is loaded through the base rather than the nipple, the caregiver ensures the nipple is attached and the plunger is in a distal position. The proximal end of the suction loading tube 50′ is placed through the opening in the base into the suction loading tube channel of the base. The distal end is placed into the baby food. The caregiver then moves the plunger proximally, and food is sucked up from the container 110 into the suction loading tube 50′ and into the food chamber. Once the desired amount of food is in the food chamber, the suction loading tube 50′ is removed from the suction loading tube channel and the nipple is placed in the infant or baby's mouth. The suction loading tube may remain in the baby food container.

Disclosed herein is an apparatus for feeding semi-solid foods to a baby, the apparatus comprising a hollow food chamber, the hollow food chamber having a proximal end and a distal end, the distal end having a food passage opening and an attachment mechanism for attaching a nipple to the food chamber; a plunger slidably engageable with an interior diameter of the hollow food chamber; a nipple; and a suction loading tube removably attachable to the hollow food chamber.

In some configurations, the attachment mechanism is at least one of the group consisting of threading, a snap fit feature, and a friction fit feature that is complementary to threading, a snap fit feature, or a friction fit feature of the nipple. The hollow food chamber may have a length, the length being less than twice the interior diameter. The distal end of the hollow food chamber may comprise a removable base, the removable base having the attachment mechanism and food passage opening disposed thereon.

In some configurations, the suction loading tube has a circumference, and the food passage hole has a circumference, the suction loading tube circumference and the food passage hole circumference being sized to allow the suction loading tube to friction fit within the food passage opening. The proximal end may be open. The apparatus may further include a cap, the cap being removably attachable to the proximal end. The nipple may comprise a nipple opening, the nipple opening having a circumference to receive the suction loading tube therethrough.

The suction loading tube may be formed of a resilient plastic. The plunger may have a diameter equal or slightly less than an interior diameter of the food chamber.

In other aspects, there is disclose an apparatus for feeding semi-solid foods to a baby, the apparatus comprising: a hollow food chamber, the hollow food chamber having a proximal end and a distal end; a base removably attachable to the distal end of the hollow food chamber, the base having a proximal side, a distal side, and sidewalls; a food passage opening extending from the proximal side to the distal side; a suction loading tube channel extending from a sidewall to a point that intersects with the food passage opening; and an attachment mechanism for attaching a nipple to the base; a hollow suction loading tube sized to engage the suction loading tube channel, the suction loading tube having a proximal end, an open distal end, and sidewalls extending from the proximal end to the distal end, and a void in a sidewall towards the proximal end; a plunger slidably engageable with an interior diameter of the hollow food chamber; and a nipple.

In some configurations, the void in the sidewall towards the proximal end of the suction loading tube meets the point that intersects with the food passage opening when the suction loading tube is inserted into the suction loading tube channel. The suction loading tube channel may have an entrance at the sidewall and the entrance may be selectably closeable. In other configurations, the entrance of the suction loading tube channel is closed unless the suction loading tube is inserted into the suction loading tube channel.

The apparatus may further comprise, for example, a spring-loaded push activated gate to selectively close the entrance. The suction loading tube may include a guide protrusion and the suction loading tube channel includes a guide groove. The suction loading tube channel may further comprise a food loading passageway extending into the hollow food chamber, the food loading passageway being selectively closeable. In some configurations, the void of the suction loading tube meets the food loading passageway when the suction loading tube is inserted into the suction loading tube channel.

There is also disclosed herein a method for feeding a baby a semi-solid food, the method comprising: (a) selecting an apparatus comprising a hollow food chamber, the hollow food chamber having a proximal end and a distal end, the distal end having a food passage opening and an attachment mechanism for attaching a nipple to the food chamber; a plunger slidably engageable with an interior diameter of the hollow food chamber; a nipple; and a suction loading tube having a distal end and a proximal end; (b) moving the plunger into the distal end of the hollow food chamber; (c) inserting the proximal end of the suction loading tube into the food passage opening; (d) inserting the distal end of the suction loading tube into a container having the semi-solid food; (e) moving the plunger proximally until a desired amount of the semi-solid food is within the hollow food chamber. The method may further comprise inserting the nipple on the attachment mechanism of the hollow food chamber.

There is thus disclosed an improved baby feeding apparatus and method of use. It will be appreciated that numerous changes may be made to the present invention without departing from the scope of the claims.

What is claimed is:

1. An apparatus for feeding semi-solid foods to a baby, the apparatus comprising
a hollow food chamber, the hollow food chamber having a proximal end and a distal end, the distal end having a food passage opening and an attachment mechanism for attaching a nipple to the food chamber;
a plunger slidably engageable with an interior diameter of the hollow food chamber;
a nipple; and
a suction loading tube removably attachable to the hollow food chamber.

2. The apparatus of claim 1, wherein the attachment mechanism is at least one of the group consisting of threading, a snap fit feature, and a friction fit feature that is complementary to threading, a snap fit feature, or a friction fit feature of the nipple.

3. The apparatus of claim 1, where the hollow food chamber has a length, the length being less than twice the interior diameter.

4. The apparatus of claim 1, wherein the distal end of the hollow food chamber comprises a removable base, the removable base having the attachment mechanism and food passage opening disposed thereon.

5. The apparatus of claim 1, wherein the suction loading tube has a circumference, and the food passage hole has a circumference, the suction loading tube circumference and the food passage hole circumference being sized to allow the suction loading tube to friction fit within the food passage opening.

6. The apparatus of claim 1, wherein the proximal end is open.

7. The apparatus of claim 1, wherein the device further includes a cap, the cap being removably attachable to the proximal end.

8. The apparatus of claim 1, wherein the nipple comprises a nipple opening, the nipple opening having a circumference to receive the suction loading tube therethrough.

9. The apparatus of claim 1, wherein the suction loading tube is formed of a resilient plastic.

10. The apparatus of claim 1, wherein the plunger has a diameter equal or slightly less than an interior diameter of the food chamber.

11. An apparatus for feeding semi-solid foods to a baby, the apparatus comprising
a hollow food chamber, the hollow food chamber having a proximal end and a distal end;
a base removably attachable to the distal end of the hollow food chamber, the base having a proximal side, a distal side, and sidewalls; a food passage opening extending from the proximal side to the distal side; a suction loading tube channel extending from a sidewall to a point that intersects with the food passage opening; and an attachment mechanism for attaching a nipple to the base;
a hollow suction loading tube sized to engage the suction loading tube channel, the suction loading tube having a proximal end, an open distal end, and sidewalls extending from the proximal end to the distal end, and a void in a sidewall towards the proximal end;
a plunger slidably engageable with an interior diameter of the hollow food chamber; and
a nipple.

12. The apparatus of claim 11, wherein the void in the sidewall towards the proximal end of the suction loading tube meets the point that intersects with the food passage opening when the suction loading tube is inserted into the suction loading tube channel.

13. The apparatus of claim 11, wherein the suction loading tube channel has an entrance at the sidewall and wherein the entrance is selectably closeable.

14. The apparatus of claim 13, wherein the entrance of the suction loading tube channel is closed unless the suction loading tube is inserted into the suction loading tube channel.

15. The apparatus of claim 14, further comprising a spring-loaded push activated gate to selectively close the entrance.

16. The apparatus of claim 11, wherein the suction loading tube includes a guide protrusion and the suction loading tube channel includes a guide groove.

17. The apparatus of claim 11, wherein the suction loading tube channel further comprises a food loading passageway extending into the hollow food chamber, the food loading passageway being selectively closeable.

18. The apparatus of claim 17, wherein the void of the suction loading tube meets the food loading passageway when the suction loading tube is inserted into the suction loading tube channel.

19. A method for feeding a baby a semi-solid food, the method comprising:
selecting an apparatus comprising
a hollow food chamber, the hollow food chamber having a proximal end and a distal end, the distal end having a food passage opening and an attachment mechanism for attaching a nipple to the food chamber;
a plunger slidably engageable with an interior diameter of the hollow food chamber;
a nipple; and
a suction loading tube having a distal end and a proximal end;
moving the plunger into the distal end of the hollow food chamber;
inserting the proximal end of the suction loading tube into the food passage opening;
inserting the distal end of the suction loading tube into a container having the semi-solid food;
moving the plunger proximally until a desired amount of the semi-solid food is within the hollow food chamber.

20. The method according to claim 19, wherein the method further comprises inserting the nipple on the attachment mechanism of the hollow food chamber.
